(19) United States
(12) Patent Application Publication
(10) Pub. No.: US 2019/0378206 A1
(43) Pub. Date: Dec. 12, 2019

(54) Computerized Relevance Scoring Engine For Identifying Potential Investors For A New Business Entity

(71) Applicant: Aingel Corp., Cupertino, CA (US)

(72) Inventors: Amr Shady, Cupertino, CA (US); OmarEbnElkhattab Hosney, Milpitas, CA (US); Prasant Sudhakaran, Rego Park, NY (US); Hariraj Jayakumar, Jersey City, NJ (US)

(21) Appl. No.: 16/002,929

(22) Filed: Jun. 7, 2018

(51) Int. Cl. G06Q 40/00; G06F 17/30

(52) U.S. Cl. CPC G06Q 40/00; G06F 17/30554

(57) ABSTRACT

The embodiments described herein provide a mechanism for inputting a set of criteria regarding a startup technology company, analyzing all existing data regarding all known venture capital firms, generating a relevancy score for each of the venture capital firms as to that particular startup technology company, and providing a report identifying the venture capital firms who are most likely to invest in the startup technology company and identifying the relevant companies in which that venture capital firm has invested in the past.

### TECHNICAL FIELD

An apparatus and method is described for identifying venture capital investors for a new business entity based on a description of the new business entity and past investment activity by venture capital investors.

### BACKGROUND OF THE INVENTION

Startup technology companies typically obtain investments from venture capital firms. These venture capital firms invest money in the startup technology companies in return for equity in the companies. There are thousands of venture capital firms across the world, and it is a daunting task to find the best set of potential investors among the many existing venture capital firms. Startup technology companies often rely upon “word of mouth” recommendations or basic website searches to identify the best candidates. This is an inefficient process for the startup technology companies as well as for venture capital firms, as the latter often are approached by startup technology companies that are in a technology space in which the particular venture capital firm is not interested. As used herein, an “investor” is a person or entity that provides money or other material asset to another person or entity in exchange for a potential profitable return. An example of an investor is a venture capital firm.

What is needed is a mechanism to assist startup technology companies in identifying venture capital firms that are most likely to invest in that company.

### SUMMARY OF THE INVENTION

The embodiments described herein provide a mechanism for inputting a set of criteria regarding a startup technology company, analyzing all existing data regarding all known venture capital firms, generating a relevancy score for each of the venture capital firms as to that particular startup technology company, and providing a report identifying the venture capital firms who are most likely to invest in the startup technology company and identifying the relevant companies in which that venture capital firm has invested in the past.

### BRIEF DESCRIPTION OF THE DRAWINGS

FIG. 1 depicts prior art hardware components of a computing device and data store.

FIG. 2 depicts software components of the computing device.

FIG. 3 depicts a relevance scoring engine

FIG. 4 depicts a keyword module used within the relevance scoring engine.

FIG. 5 depicts a deepnet used within the keyword module.

FIG. 6 depicts exemplary key words datasets for a startup technology company and a venture capital firm.

FIG. 7 depicts a report generated by a display engine.

FIG. 8 depicts another report generated by the display engine.

### DETAILED DESCRIPTION OF THE PREFERRED EMBODIMENTS

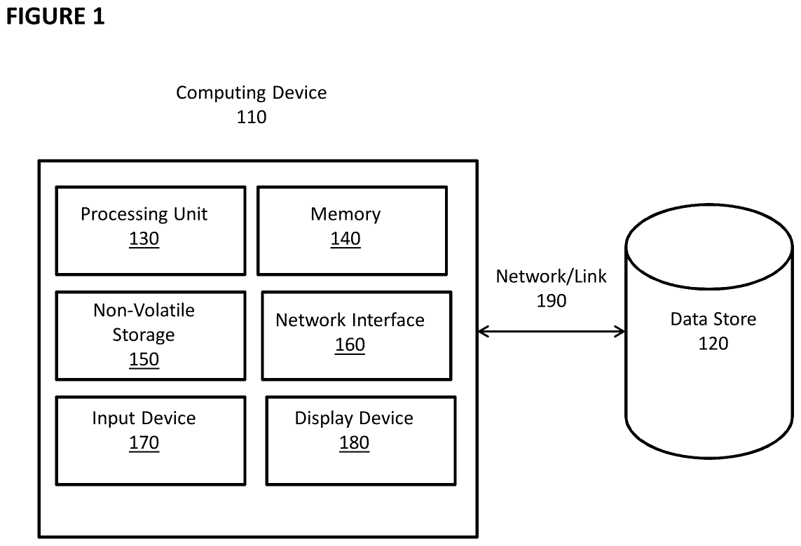

With reference to FIG. 1, computing device 110 is depicted. Computing device 110 can be a server, desktop, notebook, mobile device, tablet, or any other computer with network connectivity. Computing device 110 comprises processing unit 130, memory 140, non-volatile storage 150, network interface 160, input device 170, and display device 180. Non-volatile storage 150 can comprise a hard disk drive or solid state drive. Network interface 160 can comprise an interface for wired communication (e.g., Ethernet) or wireless communication (e.g., 3G, 4G, GSM, 802.11). Input device 170 can comprise a keyboard, mouse, touchscreen, microphone, motion sensor, and/or other input device. Display device 180 can comprise an LCD screen, touchscreen, or other display.

Computing device 110 is coupled (by network interface 160 or another communication port) to data store 120 over network/link 190. Network/link 190 can comprise wired portions (e.g., Ethernet) and/or wireless portions (e.g., 3G, 4G, GSM, 802.11), or a link such as USB, Firewire, PCI, etc. Network/link 190 can comprise the Internet, a local area network (LAN), a wide area network (WAN), or other network.

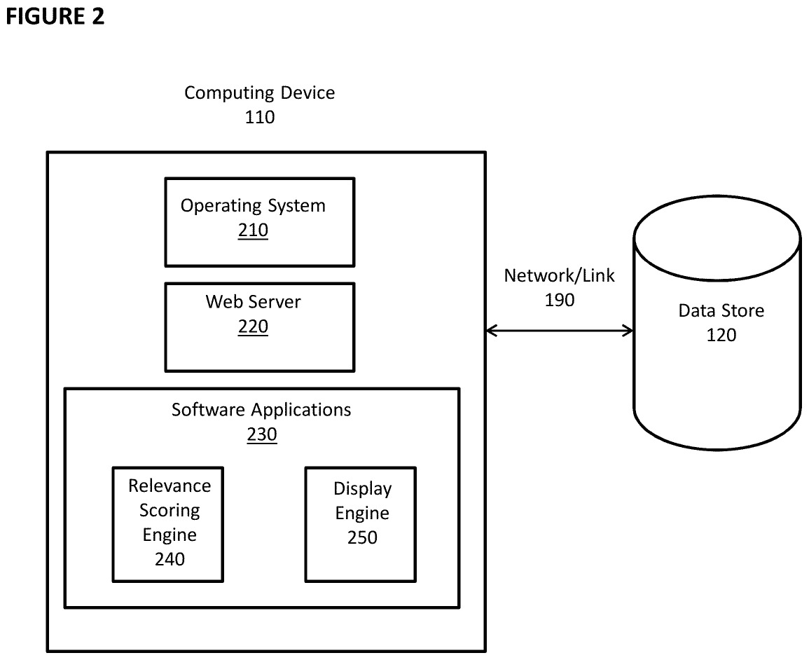

With reference to FIG. 2, software components of computing device 110 are depicted. Computing device 110 comprises operating system 210 (such as the operating systems known by the trademarks “Windows,” “Linux,” “MacOS,” “Android,” or “iOS”), web server 220 (such as Apache), and software applications 230. Software applications 230 comprise relevance scoring engine 240 and display engine 250. Operating system 210, web server 220, and software applications 230 each comprise lines of software code that can be stored in memory 140 and executed by processing unit 130 (or plurality of processing units).

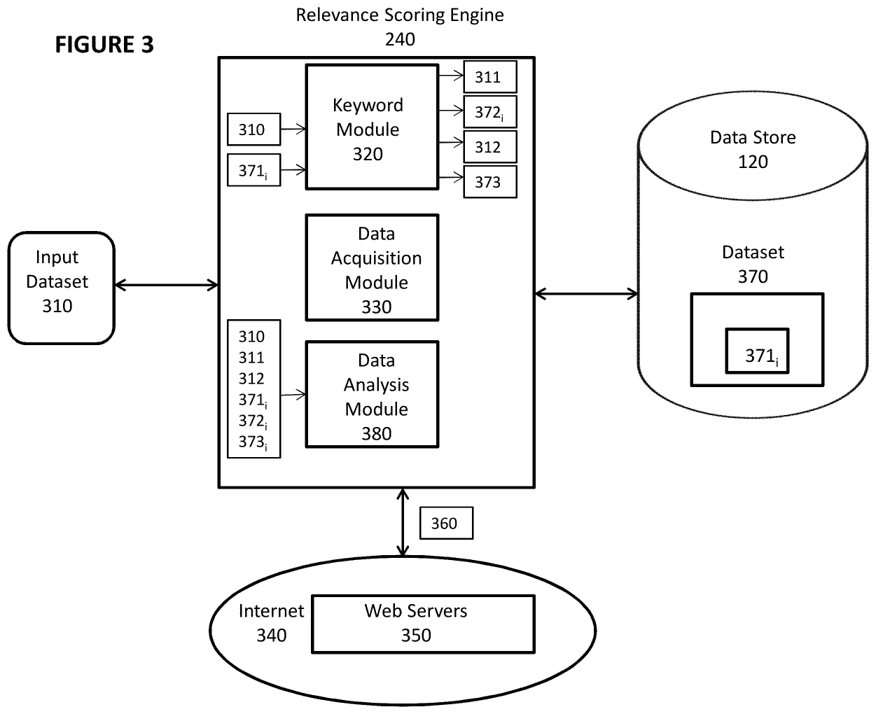

FIG. 3 depicts additional aspects of relevance scoring engine 240. In the examples that follow, it is assumed that the technology startup company of interest is called “Aingel,” and that a user wishes to obtain a list of venture capital firms who are best suited for investing in Aingel. The user first enters input dataset 310. In one example, input dataset 310 can comprise a written description of the overall business of Aingel. An example of input dataset 310 might be, “Aingel is an AI-driven analytics platform that matches startups with their ideal VCs and helps them fundraise faster.”

Keyword module 320 parses input dataset 310 to generate a company keyword dataset 311 of keywords and concepts that concisely describe the nature of Company X's business, as well as company vector representation 312 of those keywords and concepts. Company vector representation 312 is a vectorized transformation of each word in company keyword dataset 311. If input dataset 310 already is a concise list of words, then it is to be understood that company keyword dataset 311 may be the same or very similar to input dataset 310.

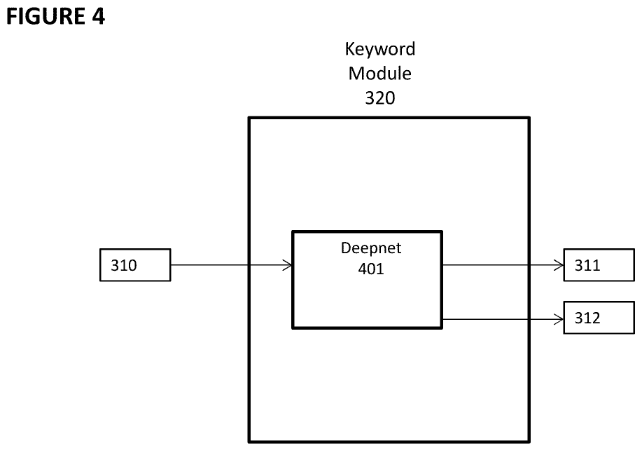

An embodiment of keyword module 320 will now be described with reference to FIG. 4. Keyword module 320 receives input dataset 310 and performs sentences and word tokenization and encoding using deepnet 401. Deepnet 401 converts the words into company keyword dataset 311 and company vector representation 312.

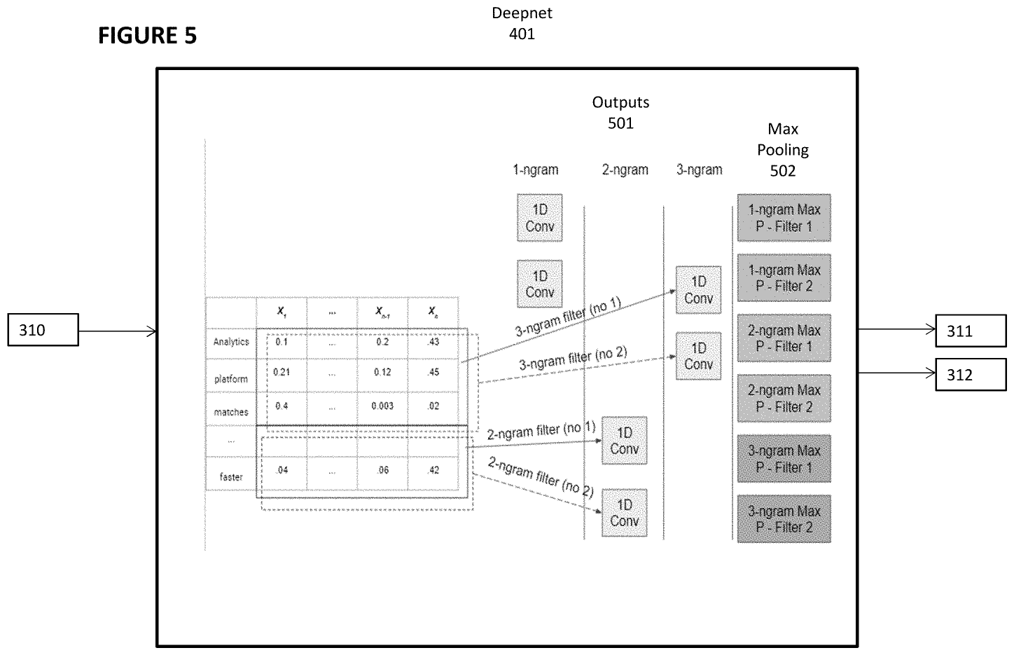

With reference to FIG. 5, deepnet 401 comprises multiple convolution layers, that address the 1-ngram, 2-ngram, 3-ngram words convolutions with 100 filters each. It is to be understood that additional convolution layers can be used. For each convolutions layer output 501, max pooling 502 is performed.

Three dense layers are then applied and the final result will be company vector representation 3122 for the category of business (the actual Y). An example of keywords from company keyword dataset 311 for the example of input dataset 310, described above, might be “(AI, analytics, invest).” Keyword module 320 then can use RMSE to measure the error between the actual Y and the predicted Y.

By providing input dataset 310 to deepnet 401 and training on the category of business (Y), the first layer will have a latent representation for the description. The latent vector together with company keyword dataset 311 will be used for matching vectors.

With reference again to FIG. 3, data acquisition module 330 then generates the universe of data that will be analyzed to identify the list of venture capital firms who are best suited for investing in Company X. In this example, data store 120 already contains dataset 370 regarding potential investors.

Dataset 370 optionally comprises data structure 371ᵢ (such as a table in a relational database) for each known venture capital firm, here referred to generically as VCᵢ, where i ranges from 1 to n, where n is the number of known venture capital firms. Each data structure 371ᵢ can contain one or more of the types of data shown in Table 1:

TABLE 1
Data Fields for Data Structure 371ᵢ for VCᵢ

Company name
Summary of company's business
Names of partners, managers, and owners of company
Total size of portfolio
For each investment made in past X years:
Target company's name
Summary of target company's business
Date of investment
Size of investment
Keywords for company

Data acquisition module 330 accesses web servers 350 over the Internet 340 and obtains additional data 360 about every known venture capital company VCᵢ and updates dataset 370 (or populates dataset 370, if dataset 370 is initially empty) with additional data 360. To obtain the additional data 360, data acquisition module 330 can perform “screen scraping” of websites or servers and/or can use APIs to obtain data from websites or servers, including obtaining data from services known by the trademarks “Twitter,” “facebook,” and “LinkedIn.”

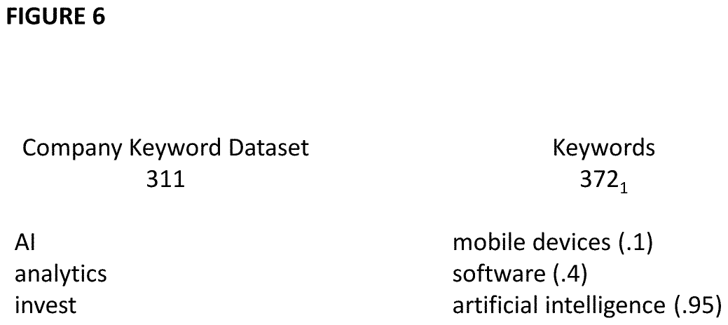

With reference to FIG. 6, keyword module 320 analyzes dataset 370 as it did for input dataset 310, and for each company VCᵢ, generates VC keyword dataset 372ᵢ and VC vector representation 373ᵢ for that company based on data structure 371ᵢ.

Data analysis module 380 receives input dataset 310, company keyword dataset 311, company vector representation 312, data structure 371ᵢ and VC keyword dataset 372ᵢ and VC vector representation 373ᵢ for each of the venture capital firms VCᵢ. For each venture capital firm VCᵢ, data analysis module 330 determines how many keywords in VC keyword dataset 372ᵢ matched a keyword in company keyword dataset 311 by comparing company vector representation 312 and VC vector representation 373ᵢ.

An example of a company keyword dataset 311 and VC keyword dataset 372₁ (for venture capital firm VC₁) are shown in FIG. 6. In this example, it can be seen that two keyword terms (“AI” and “artificial intelligence) have a strong match between the two datasets. Data analysis module 330 can further determine a relevance score (shown in parentheses in FIG. 6) based on comparison of company vector representation 312 and VC vector representation 373 for each term in VC keyword dataset 372₁ to indicate how relevant each particular term is to company keyword dataset 311.

Data analysis module 330 performs the following calculations:

Relevance Score for VCi=max(relevance) of all keywords matched*count of keywords matched

“Relevance Score for VCᵢ” is a relevance score for VCᵢ that indicates how well VCᵢ matches with Company X. It takes the largest relevance score of each keyword matched and multiplies it by the number of keywords matched. In the example of FIG. 6, the Relevance Score for VC₁ would be 0.95*2=1.90.

The Relevance Score for VCᵢ can be normalized as follows:

Normalized Score for VCᵢ=Relevance Score for VCᵢ*100/Maximum Relevance Score for Any VC

Optionally, a Relevance Score VCᵢⱼ can be calculated using the above algorithms for each VCⱼ with whom VCi has co-invested in the past, and then the Relevance Score VCᵢ can take into account the Relevance Scores VCᵢₖ for each of the k companies with which VCᵢ has co-invested. This, a VC will have a higher Relevance Score if its co-investors VCₖ for past investments have relatively high Relevance Scores themselves.

In addition, for each VCᵢ, a portfolio score can be generated for the portfolio of companies in which that VC has invested. These companies can be referred to as Pᵢⱼ, where j ranges from 1 to m, where m is the number of companies in which VCᵢ has invested.

A relevance score can be calculated for the portfolio company, Pᵢⱼ, in which VCᵢ has invested, using the same approach as for Relevance Score for VCᵢ:

Relevance Score for Pᵢⱼ=max(relevance) of all keywords matched*count of keywords matched

The Relevance Score for Pᵢⱼ can be normalized as follows:

Normalized Score for Pᵢⱼ=Relevance Score for Pᵢⱼ*100/Maximum Relevance Score for Any Pij

Data analysis module 380 also can determine a score that reflects the recency of investments by each VCᵢ in relevant portfolio companies. A normalized score for recency for each VCi can be calculated as follows:

Normalized Recency Score for VCi=1.0−(number of days since last investment by VCi in relevant space/maximum number of days since last investment by VC in relevant space)

Data analysis module 380 also can determine a score that reflects the frequency of investments by each VCᵢ in relevant portfolio companies. A normalized score for frequency for each VCᵢ can be calculated as follows:

Normalized Frequency Score for VCi=number of investments in space by VCi/maximum number of investments in space by any VC

A Comprehensive Rating for VCi can then be calculated by applying a weighting formula against the Normalized Score for VCᵢ, the Normalized Recency Score for VCᵢ, and the Normalized Frequency Score for VCᵢ. An example for a weighting formula is:

Comprehensive Rating for VCi=100*(0.5*Normalized Score for VCᵢ+0.25*Normalized Recency Score for VCᵢ+0.25*Normalized Frequency Score for VCᵢ)

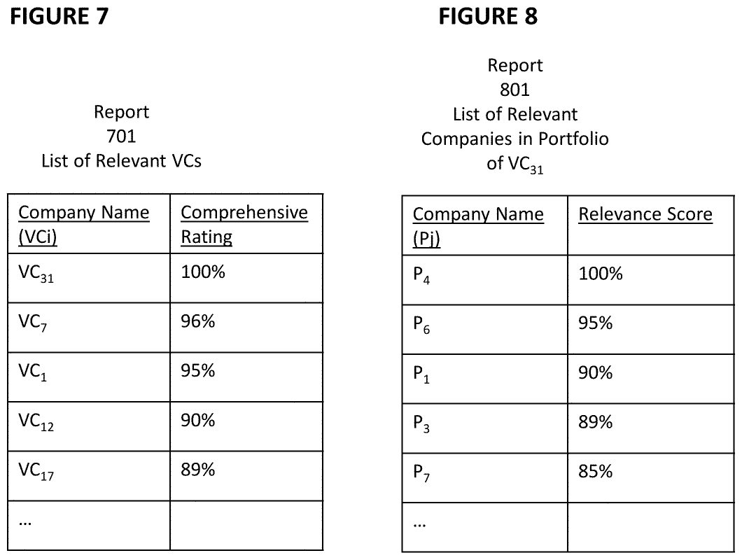

FIG. 7 shows exemplary report 701 generated by display engine 250. Report 701 shows Comprehensive Relevancy Scores VCᵢ of all n companies (or a subset thereof). FIG. 8 shows exemplary report 601 generated by display engine 250. Report 801 shows a list of the most relevant companies (Pᵢⱼ) in the portfolio of a particular VC (here, VC₃₁) based on the Relevance Score for Pᵢⱼ.

Thus, by simply inputting key words or a summary regarding a new venture (Company X), the user will be provided with a report 701 of the venture capital companies that are the most likely to invest in Company X based on their past activity. For each particular venture capital company, a user can be provided with a report 801 showing which companies invested in by a particular venture capital firm are most relevant to the business of Company X.

In another embodiment, the apparatus and methods described above can be used to generate comprehensive ratings for individuals within each venture capital company (e.g., specific members or investors of the venture capital company) and to identify the relevance of companies in which that individual has invested in the past. Reports similar to report 701 and 801 can then be generates for specific individuals as opposed to venture capital companies as a whole.

One of ordinary skill in the art will appreciate that relevance scoring engine 240 can be used for other purposes as well. For example, another type of entity—such as an accelerator (e.g., a fixed-term, cohort-based program that provides seed investment, connections, mentorship, pitch and demonstration opportunities, and educational components to a startup company to accelerate its growth) or incubator (e.g., entity that provides services such as management training or office space to a startup company)—can use relevance scoring engine 240 to find the ideal venture capital firm to visit the entity or make a presentation to the entity based on the collection of startup companies associated with that entity. Here, input dataset 310 would comprise information for all of the startups associated with that entity, and report 701 in this instance would provide a ranking of the VCs that are best suited for the overall collection of startups associated with that entity. When input dataset 310 reflects data for more than one startup, the relevance score for each VCᵢ could be the sum or average score of VCᵢ as to each individual startup in the overall collection of startups reflected in input dataset 310.

References to the present invention herein are not intended to limit the scope of any claim or claim term, but instead merely make reference to one or more features that may be covered by one or more of the claims. Materials, processes and numerical examples described above are exemplary only, and should not be deemed to limit the claims. It should be noted that, as used herein, the terms “over” and “on” both inclusively include “directly on” (no intermediate materials, elements or space disposed there between) and “indirectly on” (intermediate materials, elements or space disposed there between). Likewise, the term “adjacent” includes “directly adjacent” (no intermediate materials, elements or space disposed there between) and “indirectly adjacent” (intermediate materials, elements or space disposed there between).

What is claimed is:

1. A method of generating relevance scores for one or more potential investors for a company, comprising:
receiving, by a relevance scoring engine running on a computing device, an input dataset, the input dataset comprising a textual description of the company;
processing, by a keyword module running on the computing device, the input dataset to generate a company keyword dataset;
generating, by a data acquisition module running on the computing device, an investor dataset comprising data on known investors;
processing, by the keyword module, the investor dataset to generate an investor keyword dataset; and
generating, by a data analysis module running on the computing device, an investor relevance score for each known investor, the investor relevance score generated based upon the company keyword dataset and the investor keyword dataset.

2. The method of claim 1, further comprising: generating a report indicating the investor relevance score for one or more of the known investors.

3. The method of claim 1, further comprising: generating a report comprising a ranked list of known investors based upon investor relevance scores.

4. The method of claim 1, further comprising:
generating for each known investor, by the data analysis module, a company relevance score for each company in which the known investor has invested in the past;
generating for each known investor, by the data analysis module, a recency score, the recency score indicating the recency of investments by the known investor in a company with a company relevance score above a predetermined threshold;
generating for each known investor, by the data analysis module, a frequency score, the frequency score indicating the frequency of investments by each known investor in a company with a company relevance score above a predetermined threshold;
generating, by the data analysis module, an overall score for each known investor based upon the investor relevance score, the recency score, and the frequency score for the known investor.

5. The method of claim 4, further comprising: generating a report indicating the overall score for one or more of the known investors.

6. The method of claim 4, further comprising: generating a report comprising a ranked list of known investors based upon overall score.

7. The method of claim 1, wherein the investor dataset comprises a textual summary of previous investments by the investor.

8. The method of claim 1, wherein the investor dataset comprises data on known investors obtained from one or more web servers.

9. The method of claim, 1, wherein the investor dataset comprises data obtained from servers using APIs.

10. The method of claim 1, wherein the investor relevance score is normalized.

11. A computing device comprising a processing unit and memory, the processing unit configured to execute instructions in memory for performing the following steps:
receiving, by a relevance scoring engine running on the computing device, an input dataset, the input dataset comprising a textual description of the business entity;
processing, by a keyword module, the input dataset to generate a company keyword dataset;
generating, by a data acquisition module running on the computing device, an investor dataset comprising data on known investors;
processing, by the keyword module, the investor dataset to generate an investor keyword dataset; and
generating, by a data analysis module running on the computing device, an investor relevance score for each known investor, the investor relevance score generated based upon the company keyword dataset and, the investor keyword dataset.

12. The computing device of claim 11, wherein the processing unit is further configured to execute an instruction in memory for generating a report indicating the investor relevance score for one or more of the known investors.

13. The computing device of claim 11, wherein the processing unit is further configured to execute an instruction in memory for generating a report comprising a ranked list of known investors based upon investor relevance scores.

14. The computing device of claim 11, wherein the processing unit is further configured to execute instructions in memory for performing the following steps:
generating for each known investor, by the data analysis module, a company relevance score for each company in which the known investor has invested in the past;
generating for each known investor, by the data analysis module, a recency score, the recency score indicating the recency of investments by the known investor in a company with a company relevance score above a predetermined threshold;
generating for each known investor, by the data analysis module, a frequency score, the frequency score indicating the frequency of investments by each known investor in a company with a company relevance score above a predetermined threshold;
generating, by the data analysis module, an overall score for each known investor based upon the investor relevance score, the recency score, and the frequency score for the known investor.

15. The computing device of claim 14, wherein the processing unit is further configured to execute an instruction in memory for generating a report indicating the overall score for one or more of the known investors.

16. The computing device of claim 14, wherein the processing unit is further configured to execute an instruction in memory for generating a report comprising a ranked list of known investors based upon overall score.

17. The computing device of claim 11, wherein the investor dataset comprises a textual summary of previous investments by the investor.

18. The computing device of claim 11, wherein the investor dataset comprises data on known investors obtained from one or more web servers.

19. The computing device of claim 11, wherein the investor dataset comprises data obtained from servers using APIs.

20. The computing device of claim 11, wherein the investor relevance score is normalized.
